(19) United States
(12) Patent Application Publication
(10) Pub. No.: US 2007/0102842 A1
(43) Pub. Date: May 10, 2007

(54) Process of microlens mold

(76) Inventors: Irizo Naniwa, Odawara (JP); Masatoshi Kanamaru, Miho (JP); Takeshi Shimano, Yokohama (JP); Shigeo Nakamura, Odawara (JP); Masaya Horino, Ishioka (JP); Yumiko Anzai, Ome (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/528,517

(22) Filed: Sep. 28, 2006

(30) Foreign Application Priority Data
Nov. 10, 2005 (JP) 2005-326152

(51) Int. Cl. B29C 33/40

(52) U.S. Cl. 264/219

(57) ABSTRACT

The present invention provides a method of making a mold for manufacturing a microlens having a smooth surface and an arbitrary aspherical surface, or more specifically, an aspheric microlens of dimensions such that an aperture is equal to or less than 1 mm and a thickness is equal to or more than 0.5 mm. A mask layer having plural circular apertures with different sizes formed therein for a mold for one lens is formed on a silicon substrate. Plural holes are formed for the lens in the silicon substrate by applying anisotropic dry etching to a surface to be processed, which is the surface having the mask layer formed thereon. The depths of the respective holes vary depending on the sizes of the circular apertures. Isotropic etching is performed to remove sidewalls of the plural holes with different depths formed in the silicon substrate, thereby merging the holes into one hole corresponding to the lens.

### BACKGROUND OF THE INVENTION

1. Field of the Invention

The present invention relates to a method of making a mold for molding a microlens, and more particularly to a method of making a mold to be used to mold a minute aspheric microlens having a lens aperture of 1 mm or less.

2. Description of the Related Art

As a well known technique pertaining to a process of a microlens mold, there has been heretofore known a method of manufacture which involves the forming of a mask layer on a surface of a flat glass sheet; forming the same number of fine circular apertures as that of lenses to be made, in the mask layer in positions therein corresponding to the positions of the lenses to be made; subjecting the apertures to chemical etching to thereby form concaves of substantially a hemispherical shape; then removing wholly the mask layer; forming another mask layer on the surface of the flat sheet having the concaves formed therein; forming circular apertures, each of which is larger in size than an aperture of the concave, in the mask layer in positions therein corresponding to the positions of the respective concaves; further etching the surface of the flat sheet through the apertures; and the removing of the mask layer, and then the etching of the surface of the flat sheet throughout the entire area thereof (see, Japanese Patent Application Publication No. Hei 07-63904). This method enables high-precision manufacture of a microlens mold having smooth compound spherical surfaces thereon. Moreover, if a larger number of mask layers are to be formed, it becomes possible for a microlens mold to have a larger number of spherical surfaces.

On the other hand, as a well known technique pertaining to a method of manufacturing an aspheric microlens, there is a known method which takes steps of: sputter-depositing an Nb₂O₅ (niobium oxide) film on an SiO₂ (silicon dioxide) substrate; forming a cylindrical pattern by a photo resist on the Nb₂O₅ film; performing a post-bake to change the cylindrical pattern into a hemispherical pattern; and then transferring a shape of a lens to the Nb₂O₅ film by performing plasma etching while adjusting a mixture ratio of etching gas (see, OplusE vol. 24, no. 7 (July 2002): pp. 719-723).

There has been a growing expectation in recent years for an increase in the recording density of an optical disc and for a reduction in the size of an optical disc drive. It is hoped that an aspheric microlens having a minute lens aperture and a relatively great thickness be manufactured. Specifically, realization of such aspheric microlens is hoped as has dimensions that an aperture is equal to or less than 1 mm and a thickness is equal to or more than 0.5 mm.

However, the methods of manufacturing a microlens mold, as disclosed in the above publication No. Hei 7-63904, cannot manufacture a mold for an aspheric lens excellent for correcting spherical aberration, because this is the method of manufacture which involves forming one aperture for one lens, performing isotropic etching through the apertures, and thereby forming a hemispherical concaves, which results in a lens mold. Also, the method of manufacturing an aspheric microlens, as described in OplusE vol. 24, no. 7, can only manufacture a thin lens having a thickness of about 50 mm as against a lens aperture of 300 mm.

Although a mold is generally used to manufacture a microlens, a technique for making a mold adapted for the microlens of the above dimensions is not yet established at present.

An object of the present invention is therefore to provide a method of making a mold for manufacturing a microlens having a smooth surface and an arbitrary aspherical surface, or more specifically, an aspheric microlens of dimensions such that an aperture is equal to or less than 1 mm and a thickness is equal to or more than 0.5 mm.

To achieve the above object, the inventor proposes a process of a microlens mold as given below.

### SUMMARY OF THE INVENTION

The present invention provides a method of making a mold for manufacturing a microlens having an arbitrary aspherical surface and a thickness greater than half of a lens aperture. The method includes the steps of: forming on a silicon substrate a mask layer having plural circular apertures with different sizes; subjecting the silicon substrate to anisotropic dry etching through the plural circular apertures, thereby forming in the silicon substrate plural holes each having a respective depth depending on any one of the size of a corresponding one of the circular apertures; subjecting the silicon substrate to isotropic etching through the plural circular apertures, thereby removing sidewalls of the plural holes, and thus merging the holes with each other; and then smoothing the surface of the merged holes by isotropic etching after the removing of the mask.

The present invention also provides a method of making a mold for manufacturing a microlens having an arbitrary aspherical surface and a thickness greater than half of a lens aperture. The method includes the steps of: forming on a silicon substrate a mask layer having plural circular apertures with different sizes; subjecting the silicon substrate to anisotropic dry etching through the plural circular apertures, thereby forming in the silicon substrate plural holes each having a respective depth depending on any one of the size of the corresponding one of the circular apertures; subjecting the silicon substrate to isotropic etching through the plural circular apertures, thereby removing sidewalls of the plural holes, and thus merging the holes with each other; etching away convexes in the surface of the merged holes by anisotropic wet etching after the removing of the mask layer; and then smoothing the surface of the merged holes by isotropic etching.

The present invention also provides a method of making a mold for manufacturing a microlens having an arbitrary aspherical surface and a thickness greater than half of a lens aperture. The method includes the steps of: forming on a silicon substrate a mask layer having one circular aperture and plural ring-shaped apertures with different sizes and which are substantially concentric with the circular aperture; subjecting the silicon substrate to anisotropic dry etching through the circular aperture and the ring-shaped apertures, thereby forming in the silicon substrate plural holes each having a respective depth depending on any one of the size of the circular aperture and the radial width of the corresponding one of the ring-shaped apertures; subjecting the silicon substrate to isotropic etching through the circular aperture and the ring-shaped apertures, thereby removing sidewalls of the plural holes merge the holes with each other; and then smoothing the surface of the merged holes by isotropic etching after the removing of the mask layer.

The present invention also provides a method of making a mold for manufacturing a microlens having an arbitrary aspherical surface and a thickness greater than half of a lens aperture. The method includes the steps of: forming on a silicon substrate a mask layer having one circular aperture and plural ring-shaped apertures with different sizes and which are substantially concentric with the circular aperture; subjecting the silicon substrate to anisotropic dry etching through the circular aperture and the ring-shaped apertures, thereby forming in the silicon substrate plural holes each having a respective depth depending on any one of the size of the circular aperture and the radial width of the corresponding one of the ring-shaped apertures; subjecting the silicon substrate to isotropic etching through the circular aperture and the ring-shaped apertures, thereby removing sidewalls of the plural holes, and thus merging the holes with each other; etching away convexes in the surface of the merged holes by anisotropic wet etching removing the mask layer; and then smoothing the surface of the merged holes by isotropic etching.

The process of a microlens mold of the present invention is characterized by the forming of a film on the surface of the microlens mold, which is easy to peel off a lens material, after the smoothing step.

The process of a microlens mold of the present invention is characterized by including the step of forming on the surface of the microlens mold a film which is resistant to corrosion by an etching gas or an etching liquid for silicon, which is a material for the mold, after the smoothing step.

The present invention also provides a method of molding a microlens by using a microlens mold manufactured by the process of a microlens mold as described above. The method includes the steps of: transferring to a lens material the shape of a surface of the microlens mold having an arbitrary aspherical surface; etching the microlens mold on its surface opposite to the surface having the arbitrary aspherical surface, thereby removing a silicon substrate; and removing a film formed on the surface having the arbitrary aspherical surface.

As described above, the process of a microlens mold of the present invention enables making a mold for manufacturing a microlens having a smooth surface and an arbitrary aspherical surface, or more specifically, an aspheric microlens of dimensions such that an aperture is equal to or less than 1 mm and a thickness is equal to or more than 0.5 mm, which has hitherto been impossible.

### BRIEF DESCRIPTION OF THE DRAWINGS

FIGS. 1A to 1D are schematic sectional views showing the a flow of manufacturing processes of a process of a microlens mold according to the present invention.

FIG. 2 is a schematic sectional view showing a smoothing process according to a second embodiment of the present invention.

FIG. 3 is a schematic sectional view showing a film forming process according to a third embodiment of the present invention, which follows the forming of the microlens mold.

FIGS. 4A to 4C are schematic sectional views showing a lens molding process according to a fourth embodiment of the present invention, which follows the forming of the microlens mold.

FIG. 5 is a schematic plan and sectional view showing a process for forming circular apertures in a mask layer according to a fifth embodiment of the present invention.

### DETAILED DESCRIPTION OF THE INVENTION

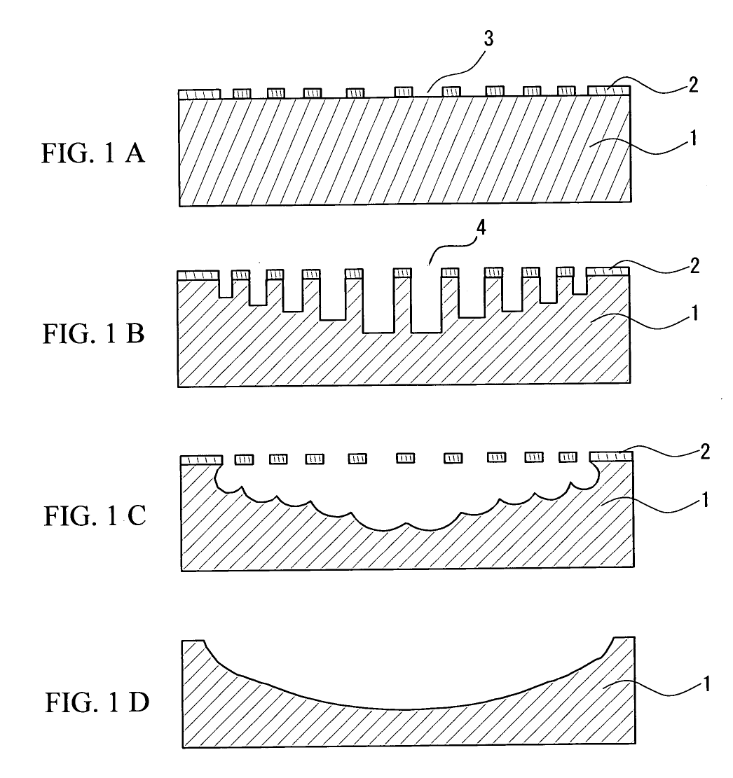

Best modes for carrying out a process of a microlens mold of the present invention will be described in detail below with reference to the accompanying drawings. FIGS. 1A to 5 are illustrative drawings of embodiments of the present invention. In these drawings, the same parts are designated by the same reference numerals and a basic configuration and operation of the embodiments are the same with each other.

### First Embodiment

The description will be given with regard to a first embodiment of the process of a microlens mold of the present invention. FIGS. 1A to 1D are schematic sectional views showing a flow of manufacturing processes of the first embodiment. First, as shown in FIG. 1A, a mask layer 2 is formed on a single crystal silicon substrate 1. A resist pattern having plural circular apertures with different sizes is formed for one lens on the mask layer 2 by photolithography. The mask layer 2 is etched using the resist pattern, and plural circular apertures 3 of different sizes are formed for the lens in the mask layer 2. An Al (aluminum) layer deposited by sputter, a silicon dioxide layer or the like may be used as the mask layer 2.

Then, as shown in FIG. 1B, plural holes 4 are formed in the silicon substrate 1 by subjecting a surface to be processed, specifically the surface having the mask layer 2 formed thereon, to anisotropic dry etching using an aperture pattern of the circular apertures 3 formed in the mask layer 2. Due to a microloading effect during this process, the depths of the holes become greater as the sizes of the corresponding one of the circular apertures in the mask layer are larger, and a longer etching time causes a larger difference in depth between the holes, which is dependent on the respective sizes of the circular apertures. Thus, the circular apertures 3 formed in the mask layer 2 are designed to have dimensions such that the sizes become larger as the circular apertures 3 are located closer to a place corresponding to the center section of the lens. The microloading effect does not occur when the sizes of the circular apertures in the mask layer are equal to or more than a certain value. In the first embodiment, the sizes of the circular apertures 3 lie between 5 μm and 40 g/m inclusive.

In the first embodiment, the conditions of the anisotropic dry etching (DRIE) are as follows: an etching gas (SF₆) flow rate of 120 sccm, a passivation gas (C₄F₈) flow rate of 80 sccm, a percentage of venting of 55%, a source power of 1000 W, an RF power of 110 W, a pressure of 1.7 to 1.8 Pa, and an etching time to passivation time ratio of 7 to 3.

Desirably, the anisotropic dry etching continues until the difference in depth between the deepest hole in the place corresponding to the center section of the lens and the shallowest hole in a place corresponding to the rim of the lens becomes equal to or more than 200 μm.

Then, as shown in FIG. 1C, isotropic etching is performed to remove sidewalls of the plural holes with different depths formed in the silicon substrate by the anisotropic dry etching in the former process, thereby merging the holes with each other. In the first embodiment, the conditions of isotropic dry etching are as follows: an etching gas (SF₆) flow rate of 100 sccm, a percentage of venting of 55%, a source power of 900 W, an RF power of 20 W, and a pressure of 1.7 Pa to 1.8 Pa.

This process may be performed by, instead of by the isotropic dry etching, isotropic wet etching of the single crystal silicon by using a mixed solution of hydrofluoric, nitric acid, and acetic acid, or the like.

Then, as shown in FIG. 1D, the mask layer is removed, and smoothing is performed to smooth the surface of a mold. Isotropic dry etching or isotropic wet etching, for example, can be employed for the smoothing.

As described above, the first embodiment allows an arbitrary design of the sizes and arrangement of the circular apertures 3 to be formed in the mask layer 2, thus making it possible to form a mold for molding a microlens having an arbitrary aspherical surface and a desired thickness. Specifically, the first embodiment enables making a mold for molding an aspheric microlens of dimensions such that a lens aperture is equal to or less than 1 mm and a thickness is equal to or more than 0.5 mm. The first embodiment also includes the smoothing mentioned above, thus making it possible to achieve a microlens mold having a smooth surface.

### Second Embodiment

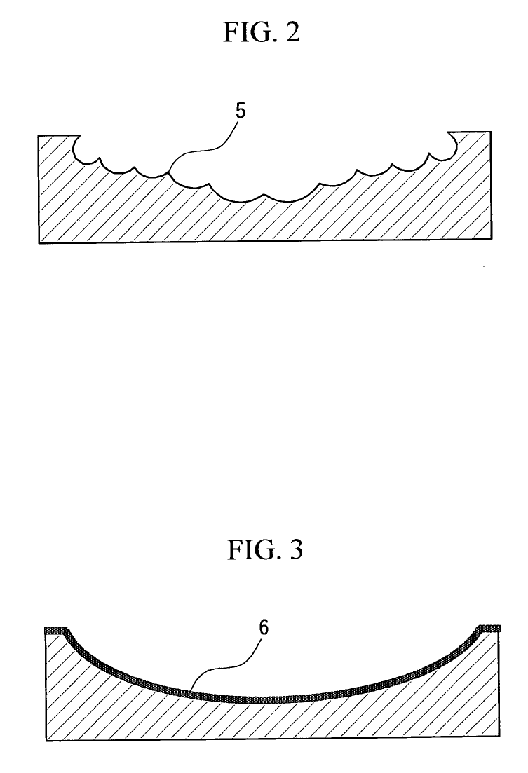

The description will be given with regard to a second embodiment of the process of a microlens mold of the present invention. The second embodiment is characterized by a smoothing process performed by a different method from that of the first embodiment. Incidentally, the other processes of the second embodiment are the same as those of the first embodiment. As shown in FIG. 2, the smoothing process of the second embodiment involves the subjecting of the single crystal silicon to anisotropic wet etching using a KOH (potassium hydroxide) or TMAH (tetramethyl ammonium hydroxide) aqueous solution to remove large convexes 5 on the surface of a lens mold, and then performing isotropic wet etching to smooth the surface of the lens mold. In this manner, the second embodiment can achieve a microlens mold having a smooth surface.

### Third Embodiment

The description will be given with regard to a third embodiment of the process of a microlens mold of the present invention. The third embodiment is characterized by the forming of a film 6, which is easy to peel off a lens material, on the surface of the mold as shown in FIG. 3 after the forming of the microlens mold on the surface of the silicon substrate by the method of the first or second embodiment. In a case where, for example, glass is used for the lens material, the film 6 can be made of carbon. Thus, the third embodiment can achieve a microlens mold which facilitates the peeling off of a microlens after transfer.

### Fourth Embodiment

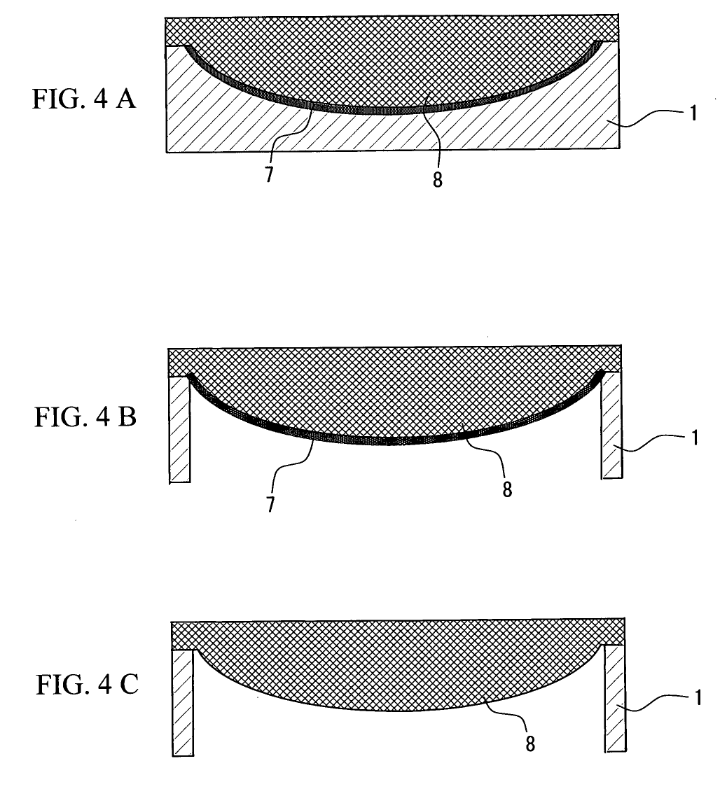

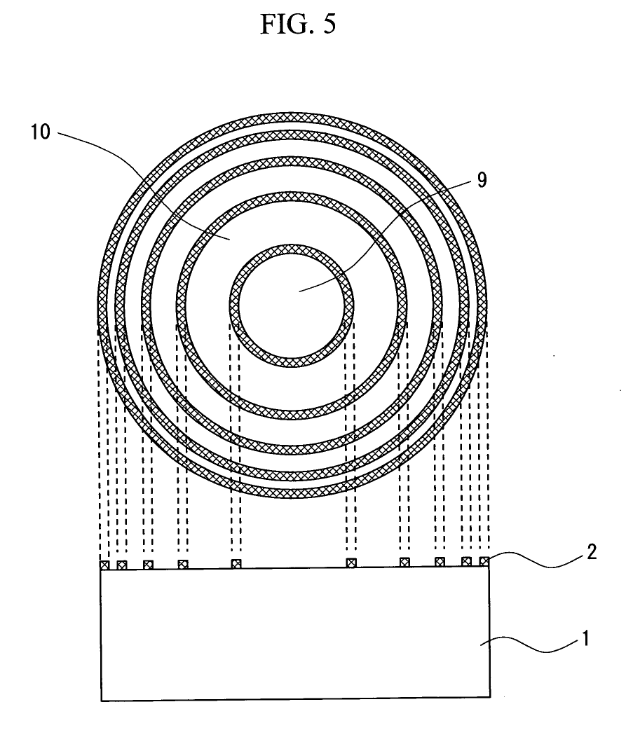

The description will be given with regard to a fourth embodiment of the process of a microlens mold of the present invention. The fourth embodiment is characterized by the forming of a passivation layer 7, which is resistant to corrosion by an etching gas or an etching liquid for silicon, on the surface of the mold as shown in FIG. 4A after the forming of the microlens mold on the surface of the silicon substrate by the method of the first or second embodiment. The passivation layer 7 can be made of, for example, Al, SiO₂, or the like.

The lens material is transferred to the microlens mold processed in the manner as above mentioned. Then, the microlens mold is etched on its rear surface as shown in FIG. 4B. And then, the passivation layer 7 is removed as shown in FIG. 4C. This makes it possible to expose a lens surface 8 without peeling off the microlens from the microlens mold. Thus, the fourth embodiment enables the molding of the microlens without causing damage to the lens surface 8.

### Fifth Embodiment

The description will be given with regard to a fifth embodiment of the process of a microlens mold of the present invention. The fifth embodiment is characterized by the process of forming the circular apertures in the mask layer, which is performed by a different method from that of the first embodiment. Incidentally, the other processes of the fifth embodiment are the same as those of the first embodiment. As shown in FIG. 5, the aperture forming process of the fifth embodiment involves forming a circular aperture 9 in the mask layer 2 in a place corresponding to the center section of the lens, and forming around the circular aperture 9 plural ring-shaped apertures 10 which are concentric with the circular aperture 9. The radial widths of the ring-shaped apertures becomes narrower as the ring-shaped apertures are located closer to the place corresponding to the rim of the lens. This method can be also used to manufacture a microlens mold having an arbitrary aspherical surface and a desired thickness.

Although descriptions have been given with reference to the specific embodiments with regard to the methods of manufacturing the microlens mold of the present invention, it is to be understood that the present invention is not limited to the above embodiments. It should be apparent that various changes and modifications can be made to the configuration and function of the invention related to these and other embodiments by those skilled in the art without departing from the basic concept and scope of the invention.

What is claimed is:

1. A method of making a mold for manufacturing a microlens having an arbitrary aspherical surface and a thickness greater than half of a lens aperture, comprising the steps of:
forming on a silicon substrate a mask layer having a plurality of circular apertures with different sizes;
subjecting the silicon substrate to anisotropic dry etching through the plurality of circular apertures, and thereby forming in the silicon substrate a plurality of holes each having a respective depth depending on any one of the size of the corresponding one of the circular apertures;
subjecting the silicon substrate to isotropic etching through the plurality of circular apertures, thereby removing sidewalls of the plurality of holes, and thus merging the holes with each other; and
smoothing the surface of the merged holes by isotropic etching after the removing of the mask layer.

2. A method of making a mold for manufacturing a microlens having an arbitrary aspherical surface and a thickness greater than half of a lens aperture, comprising the steps of:
forming on a silicon substrate a mask layer having a plurality of circular apertures with different sizes;
subjecting the silicon substrate to anisotropic dry etching through the plurality of circular apertures, and thereby forming in the silicon substrate a plurality of holes each having a respective depth depending on any one of the size of a corresponding one of the circular apertures;
subjecting the silicon substrate to isotropic etching through the plurality of circular apertures, thereby removing sidewalls of the plurality of holes and thus merging the holes with each other; and
etching away convexes in the merged holes by anisotropic wet etching after the removing of the mask layer, and thereafter smoothing the surface of the merged holes by isotropic etching.

3. A method of making a mold for manufacturing a microlens having an arbitrary aspherical surface and a thickness greater than half of a lens aperture, comprising the steps of:
forming on a silicon substrate a mask layer having one circular aperture and a plurality of ring-shaped apertures with different sizes and which are substantially concentric with the circular aperture;
subjecting the silicon substrate to anisotropic dry etching through the circular aperture and the ring-shaped apertures, and thereby forming in the silicon substrate a plurality of holes each having a respective depth depending on any one of the size of the circular aperture and the radial width of a corresponding one of the ring-shaped apertures;
subjecting the silicon substrate to isotropic etching through the circular aperture and the ring-shaped apertures, thereby removing sidewalls of the plurality of holes, and thus merging the holes with each other; and
smoothing the surface of the merged holes by isotropic etching after the removing of the mask layer.

4. A method of making a mold for manufacturing a microlens having an arbitrary aspherical surface and a thickness greater than half of a lens aperture, comprising the steps of:
forming on a silicon substrate a mask layer having one circular aperture and a plurality of ring-shaped apertures with different sizes, which are substantially concentric with the circular aperture;
subjecting the silicon substrate to anisotropic dry etching through the circular aperture and the ring-shaped apertures, thereby forming in the silicon substrate a plurality of holes each having a respective depth depending on any one of the sizes of the circular aperture and the radial width of a corresponding one of the ring-shaped apertures;
subjecting the silicon substrate to isotropic etching through the circular aperture and the ring-shaped apertures, thereby removing sidewalls of the plurality of holes, and thus merging the holes with each other; and
etching away convexes in the surface of the merged holes by anisotropic wet etching after the removing of the mask layer, and therefore smoothing the surface of the merged holes by isotropic etching.

5. The process of a microlens mold according to any one of claims 1 to 4, further comprising the step of forming on the surface of the microlens mold a film which is easy to peel off a lens material after the smoothing step.

6. The process of a microlens mold according to any one of claims 1 to 4, further comprising the step of forming on the surface of the microlens mold a film resistant to corrosion by an etching gas or an etching liquid for silicon, which is a material for the mold, after the smoothing step.

7. A method of molding a microlens by using a microlens mold manufactured by the process of a microlens mold according to claim 6, comprising the steps of:
transferring to a lens material the shape of a surface of the microlens mold having an arbitrary aspherical surface, therefore etching the microlens mold on its surface opposite to the surface having the arbitrary aspherical surface, thereby removing a silicon substrate, and thus removing the film formed on the surface having the arbitrary aspherical surface.
